(19) United States
(12) Patent Application Publication
(10) Pub. No.: US 2006/0233206 A1
(43) Pub. Date: Oct. 19, 2006

(54) Frequency doubling crystal and frequency doubled external cavity laser

(76) Inventors: Carla Miner, Carp (CA); Sherri Sparling, Nepean (CA); Barbara Paldus, Portola Valley, CA (US); Steven Wallace, Nepean (CA); Bruce Richman, Sunnyvale, CA (US); Chris Rella, Sunnyvale, CA (US); Guido Knippels, Sunnyvale, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/107,254

(22) Filed: Apr. 15, 2005

(51) Int. Cl. H01S 3/10

(52) U.S. Cl. 372/22

(57) ABSTRACT

A periodically poled second harmonic generating crystal having a long axis, said crystal comprising Magnesium Oxide doped Congruent Lithium Niobate, Magnesium Oxide doped Stoichiometric Lithium Niobate, Stoichiometric Lithium Tantalate or Potassium Titanyl Phosphate wherein the poling planes of said periodically poled crystal are canted relative to said axis and a doubled, external cavity laser utilizing said crystal, comprising an external cavity pump laser section and an extra-cavity frequency doubling section.

### FIELD OF THE INVENTION

This invention relates to non-linear, frequency doubling crystals, and to solid state lasers which utilize such crystals. Such crystals are particularly useful for enabling frequency doubled lasers emitting light in the 300 nm to 700 nm wavelength range. The lasers fabricated using the frequency doubling crystals of the present invention can be advantageously used in a variety of applications including biophotonic instruments.

### BACKGROUND OF THE INVENTION

The forces driving the development of new instrumentation for applications in fields such as biomedical research and clinical diagnostics are related. First, there is the desire for new capabilities and improved performance. In the last 30 years entirely new and sizable industry segments have resulted from the development of instrumentation with new capabilities. These instruments have significantly accelerated advances in fields such as immunology, oncology and drug discovery. A second important driver is the need to continuously improve instrument economics. The initial cost, operating cost, reliability, size, measurement speed and ease of use of such instruments has a major influence on how widely such instruments are deployed and utilized. As a result, the economics of an instrument can ultimately influence the rate at which new cures and drug treatments are discovered and the quality of healthcare available to the public, so that the capabilities and economics of instrumentation may be more important in the biomedical industry than in any other.

The use of lasers in biomedical instruments has been fundamental to the development of new instrument capabilities. Instruments to study cells, genes and proteins are all critically dependent on lasers for their function. These instruments include flow cytometers, DNA sequencers, array scanners, microplate readers, confocal microscopes and mass spectrometers. It is therefore not surprising that improvements in the performance and economics of these instruments is also influenced, and in some cases limited, by the performance and economics of their laser component. As these instruments advance from basic laboratory research tools to diagnostic and drug discovery applications, the instruments, and especially the lasers used in them, are frequently required to simultaneously deliver both better performance and economics.

Many laser-based biomedical instruments were conceived around gas tube lasers (e.g., Argon ion lasers). The generally good optical performance characteristics of Argon ion lasers have been pivotal to their adoption and use in instruments. However, Argon ion lasers have significant limitations: size (12×15×30 cm). for the laser head and a similar size for the power supply, power consumption (˜2.5 kW), and limited operational life ((MTTF˜5,000 hours). Moreover, Argon ion lasers are not precisely single mode, i.e., they have imperfect side mode suppression.

In the past, Argon ion lasers were the only source of the blue (488 nm) and green (514 nm) light needed to induce the fluorescence upon which the operation of many diagnostic/analytical instruments depends. Argon ion lasers were adequate as long as the instruments in which they were used were confined to basic research applications. In today's drug discovery labs instrument utilization frequently comes closer to a production environment than to a research lab. This means instrument reliability has become increasingly critical. At the same time, researchers are looking for more capability from their instruments, which often means that more wavelengths and consequently more lasers are being incorporated into each instrument. As a result, laser size, power consumption and operating lifetime have become critical differentiators.

In flow cytometry, for example, efforts are underway to develop instruments suitable for point of care (POC) deployment, i.e. in doctors offices or mobile labs. Flow cytometers use lasers to analyze blood cells. By analyzing the way laser light is scattered by cells having fluorescent tags, blood cells can be counted and sorted by cell type and pathogenic condition. One motivation for deploying such instruments close to the point of care is to provide immediate results and minimize sample loss or mishandling. The speed and reliability of diagnosis can be improved by moving these instruments close to the patient. Another case for POC diagnostic instruments is in the battle against HIV and AIDS. One of the biggest challenges in places such as sub-Saharan Africa is to determine who is HIV positive. This frequently requires a blood test. Mobile labs with clinical diagnostic grade cytometers able to provide rapid on-site results, appear likely to-be the only truly effective way to tackle this problem. As instruments such as flow cytometers migrate from research labs to clinical settings, the importance of measurement accuracy and repeatability increases. In this case laser intensity noise and wavelength stability over the lifetime of the laser are two key factors limiting the deployment and utilization of the instruments.

Argon ion lasers are not capable of meeting these new requirements for high reliability, small size, high operating efficiency and superior optical performance. See, for example, “Laser Focus World”, August 2004, pp 69-74. These requirements have driven efforts to find a replacement for Argon ion lasers by new solid-state laser platforms with enhanced features and performance to meet the evolving needs of the bio-instrument community. Bio-analytical instrumentation is a demanding application that requires a high performance solution. In comparison to an Argon ion laser, a typical 20 mW diode pumped, solid state laser (DPSS) emitting, for example, at 532 nm can produce an optical beam of similar quality and stability in 10% of the volume while consuming less than 5% of the power, plus having an in-service lifetime that is at least twice as long.

Because these characteristics are increasingly important in biomedical applications, a growing need is evolving for a solid-state alternative to existing lasers, particularly in the 300 nm (near UV) to 600 nm (orange) and 700 nm (red) wavelength range. Specific wavelengths which are especially important in biophotonic analysis include 355, 360, 405, 430, 460, 473, 488, 506, 514, 532 and 560 nm. There is especially a need for violet (405 nm), cyan (blue 488 nm), and green (532 nm) lasers that do not compromise optical performance. To meet the new requirements of biomedical applications solid-state lasers will require good optical performance (laser intensity noise, wavelength stability and side mode suppression), reliability that is two to four times better than incumbent (e.g., Argon ion) technologies, a much smaller form factor, and lower input power and heat dissipation in operation. Such performance demands constrain the available design space for such a solid state laser. It should be noted that the improved blue lasers of the present invention have numerous non-medical applications including aerosol detection and characterization, graphics display and wafer inspection.

Using the generation of cyan i.e., blue (488 nm wavelength) light as an example, material and design limitations have heretofore made this wavelength unattainable in a practical way using the laser designs typically employed to produce other visible light wavelengths such as green. These older laser designs start with a high power semiconductor laser that produces light in the near-infrared region (808 nm) which light is then used to pump a material (e.g., Neodymium Yttrium Aluminum Garnet) that transforms the light further into the infrared (1064 nm) which is then converted to visible (green 532 nm) light by a frequency doubling crystal through a process known as frequency doubling or second-harmonic generation (SHG).

A known architecture for generating cyan light, using a semiconductor pump laser, is shown in FIG. 4, i.e., intracavity SHG using an optically pumped semiconductor laser (OPSL). OPSL based SHG was apparently first proposed by Aram Moradian in 1991 and the first commercial solid-state cyan laser was offered in 2001. OPSL technology, similar to the older solid-state laser technology, uses a 808 nm pump laser. The gain material is a semiconductor-based, vertical external cavity surface emitting laser (VECSEL). In this design the SHG crystal was Lithium Borate (LBO), and it and a wavelength selective element which is used to select a single longitudinal mode, were both located inside the optical cavity. Such high finesse VECSEL cavities can be used to achieve the large intracavity power required for frequency doubling. The dichroic output mirror of the VECSEL then transmits the 488 nm radiation generated inside the cavity. However, this architecture is both complex and expensive, owing inter alia to the heat dissipation required for the VECSEL. Also, the yield of the VECSEL material itself is generally not high. Finally, the reliability of the product is limited by the lifetime of both the 808 nm pump laser and the VECSEL material.

Alternative intracavity designs have been proposed, e.g., the VECSEL is electrically pumped rather than optically pumped, such as the Novalux Protera laser. However, the output power demonstrated with this design using Potassium Niobate (KNO) as the doubling crystal, is not believed to exceed 15 mW. More recently, other prior art workers have reported a 40 mW intracavity SHG laser that used a periodically poled Potassium Titanyl Phosphate (KTP) doubling crystal. However, the VECSEL architecture used creates an intracavity beam having a large divergence angle, i.e., an angle which is substantially larger than the acceptance angle of a periodically poled frequency doubling crystal, which perforce leads to poor conversion efficiency.

As already indicated, the requirements for the next generation biomedical devices dictate a low-cost laser with high reliability and improved optical performance (i.e. low noise). The low-cost requirement is not easily met with the current solid-state gain medium solution. These solutions typically require expensive optical pumping schemes, whereas in contrast semiconductor lasers can be mass-produced for little cost and can be electrically pumped. A challenge is how to make a laser manifesting low noise (both low intensity noise and a stable emission wavelength at a selected wavelength in the 300 to 700 nm range).

Reliability is also an issue. There has been a tremendous effort to develop a semiconductor laser for 980 nm telecom applications. These lasers are required to have lifetimes of 20 years or longer, are deployed in harsh environments such as at the bottom of the ocean and must cope with large temperature variations. This multi-billion dollar high-volume telecom market has been the predominant incentive to develop such high-reliability 980 semiconductor lasers. No such market opportunity exists for semiconductor VECSELs, therefore the reliability of these devices is much less developed. The size of the biophotonics market is currently not big enough to warrant a serious effort to enhance the reliability of these VECSEL devices to the same level as the telecom 980 pump lasers. VECSELs will not easily achieve the same reliability, and at best will get decent reliability only if additional reliability development is funded, thereby further increasing the ultimate price of a VECSEL based product.

Very shortly after the development of the laser, the frequency conversion of laser radiation by nonlinear optical crystals became an important technique widely used in quantum electronics and laser physics. The fundamental physics of three-wave light interactions in nonlinear optical materials is, in general, understood, and the basic principles of second-harmonic generation (SHG) using periodically poled, non-linear crystals are also known. In second-harmonic generation (SHG), an infrared laser which emits light of frequency ω₁ is passed through a nonlinear crystal and light emerges with frequency 2ω₁. However, a critical factor is, of course, the efficiency of the frequency doubling (second harmonic generation) by the non-linear crystal and scientists continue to search for more efficient nonlinear optical materials to achieve the enhanced conversion efficiency required by new applications.

Using the generation of 488 nm blue light as an example, it is known that blue light can be generated by using nonlinear crystals to “upconvert” the infrared wavelength light (976 nm) produced by a semiconductor diode laser. A preferred approach to the production of near UV and visible light (λ=300-700 nm) is to use a non-linear material which has been periodically poled. In this technique, the inherent wavelength conversion efficiency of the non-linear crystal is enhanced by imposing a periodic reversal in the orientation of the polarization of the crystal along the direction of light propagation. Potassium Titanyl Phosphate (KTP),; Lithium Niobate (LN) and Lithium Tantalate (LT), especially stoichiometric LT are all non-linear, crystalline materials which have a variety of uses in non-linear optics, including second harmonic generation. For example, periodically poled Potassium Titanyl Phosphate (PPKTP) has been used in the frequency doubling of near-infrared laser light to produce visible blue light. See, for example, WIPO Application No. 98/36109, for a detailed description of a method for transforming a crystal of KTP into PPKTP in order to permit quasi phase matching, which enhances conversion efficiency. A recent treatise which provides an excellent summary is “Compact Blue Green Lasers” by W. R, Risk, T. R. Gosnell and A. V. Nurmikko, Cambridge University Press, 2003, ISBN 0-521-62318-9. See especially Chapters 2-5 and most especially pages 71- 90.

The periodic poling approach is well suited to many of the materials that are traditionally used for blue-green generation, e.g., LN, LT, and KTP. These materials are ferroelectric, which means that below a certain temperature (called the Curie temperature), they exhibit a spontaneous electric polarization even when no external electric field is applied. This polarization arises from an internal separation of charge due to the spatial arrangement of the atoms in the crystal. This separation of charge defines a direction connecting the negative center-of-charge to the positive center-of-charge; thus, ferroelectric materials have a “polar axis” that acts as a directional reference by which the crystal can “distinguish” the difference between an applied electric field that points in the same direction as the spontaneous polarization and one that points in the opposite direction.

The process of aligning the direction of the spontaneous polarization is called “poling,” and a region of the crystal in which the spontaneous polarization has the same alignment is called a ferroelectric domain. Thus, a crystal having periodic reversals of the spontaneous polarization is said to be “periodically poled” or “periodically domain-inverted”. The domain boundary separating contiguous regions with reversed polarization is referred to as a “poling plane”. The two immediately contiguous regions having opposite polarization are referred to as a “period” of the grating structure (i.e., the multi-period periodically poled structure which, in a crystal of the size normally used, will comprise from about 1000 to 10,000 periods.

Several methods have been demonstrated to produce a domain-inverted structure in some nonlinear materials with a period of a few microns. At present, the most widely used method involves the definition of a periodic patterned electrode on one surface of the crystal. This periodic electrode can be a patterned metal film, or a photo resist layer overlaid with a metal film or a liquid electrolyte. A uniform electrode is applied over the entire opposite surface of the crystal. An electric field is applied to these electrodes causing inverted domains begin to nucleate under the regions where the patterned electrode is in contact with the crystal. Under the influence of the applied field, these domains grow until they fill the area directly under the patterned electrode and extend across the entire thickness of the crystal to the opposite crystal surface. Periodic poling has been achieved using this approach in a variety of materials including LN, LT and KTP. The width of one period will generally vary from about 2 microns to about 30 microns. When used with the crystal materials of the present invention to generate light in the 300 to 700 nm region the periods will suitably have a width of from about 4 to about 7.5 microns. The width is selected in accordance with known principles to achieve the maximum conversion efficiency at the selected crystal operating temperature. The width selected is that which minimizes the phase shift between the fundamental (input) wave and the second harmonic (frequency doubled) waves. The periodically poled crystals described in this invention are fabricated to have a specific period width. The selected width of the period depends on the wavelength of the laser radiation that is to be produced in the SHG process, as well as on the crystal composition. The optimal period width for any given crystal material is, in general, determined by the dispersion dependence of the refractive index of the crystal material on the wavelength of the incident light. Crystals with large dispersion require short poling periods in order to achieve effective phase matching. Absent phase matching it is not possible to achieve efficient laser beam generation at the second-harmonic frequency. Since, as indicated, the refractive index dispersion is, in general, a function of incident light wavelength, a given poling period only works effectively for a limited range of input light frequencies. If the input laser frequency is changed a new poling period needs to be produced in order to generate substantial second harmonic radiation. For example, in the case where the input laser light frequency is 976 nm and the frequency doubled radiation is 488 nm, the periods for the materials described as suitable in the practice of the present invention are as follows:

MgO doped Congruent PPLN=5.28 micron (Co PPLN)

MgO doped Stoichiometric PPLN=5.26 micron (St PPLN)

Stoichiometric PPLT=6.1 micron (St PPLT)

PPKTP=6.7 micron

The device depicted in FIG. 5 shows a diode laser with a low facet reflectivity in close proximity to the flat, polished end of a nonlinear frequency doubling crystal with a refractive index ˜2, and therefore a reflectivity of ˜11%. Thus, the reflection from the laser diode's own facet will compete for control of the laser with the reflection from the end of the frequency doubling crystal, which can result in amplitude and/or frequency instability. It has been found that even relatively weak optical feedback can sustain a chaotic regime of low frequency fluctuations with sudden irregular intensity dropouts. See e.g., K. Petermann, IEEE J. Sel. Top. Quantum Electron. 1, 480 (1995); T. Morikawa et. al., Electron. Lett. 12, 435 (1976); and I. Koryukin and P. Mandel, Phys. Rev. A 70, 053819 (2004). The reflection from the endface of the doubling crystal can be partially suppressed by use of an anti-reflection coating, and/or by angling the endface of the crystal relative to the beam path, although the latter approach may not be compatible with a coplanar mounting arrangement. Even though the anti-reflection coating can reduce the reflectivity of the crystal facet, even a weak reflection from the endface can lead to instability in the pump laser wavelength. A known approach involves, in addition to suppressing the reflection from the crystal endfaces with an anti-reflection coating, also applying an anti-reflection coating to the diode laser facet in order to suppress that reflection as well. Although the general laser geometry shown in FIG. 5 is in accordance with the teaching of the present invention, not shown in FIG. 5 are the significant improvements to the design (and performance) of the laser which are achieved by use of the crystals of the present invention.

It is therefore an object of the present invention to provide improved frequency doubling crystals and solid state lasers utilizing such improved frequency doubling crystals.

### DESCRIPTION OF THE DRAWINGS

FIG. 1A shows the general configuration of a frequency doubling crystal which would be suitable for the practice of the present invention. As can be seen the configuration of the crystal is substantially a right angle rectangular parallelepiped. However, the arrangement of the domain boundaries shown in FIG. 1A are in accordance with the prior art i.e., the domain boundaries are perpendicular to the light path, which is through the crystal along its X axis and also perpendicular to the crystal side walls.

Suitable X, Y, and Z dimensions for crystals for the practice of the present invention (in millimeters) are:

X=10 to 30, Y=0.5 to 3.0, Z=0.5 to 1.0

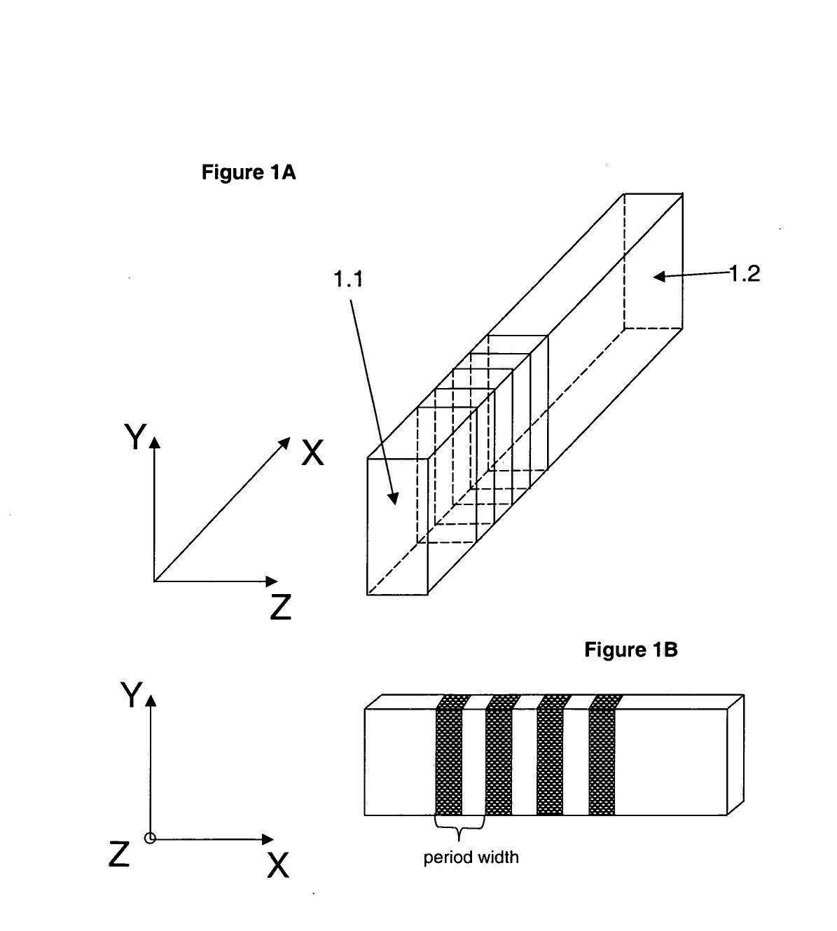

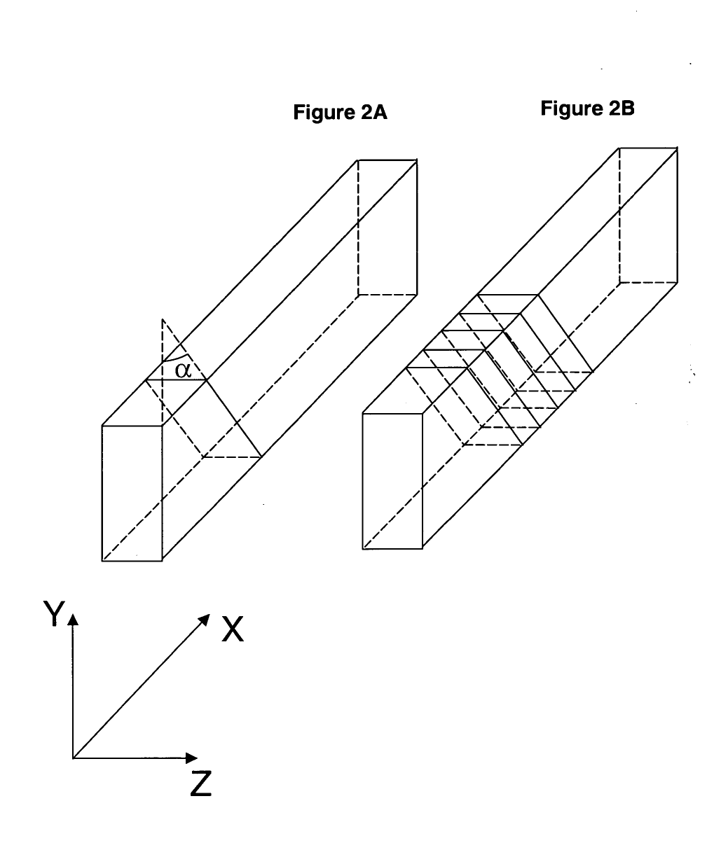

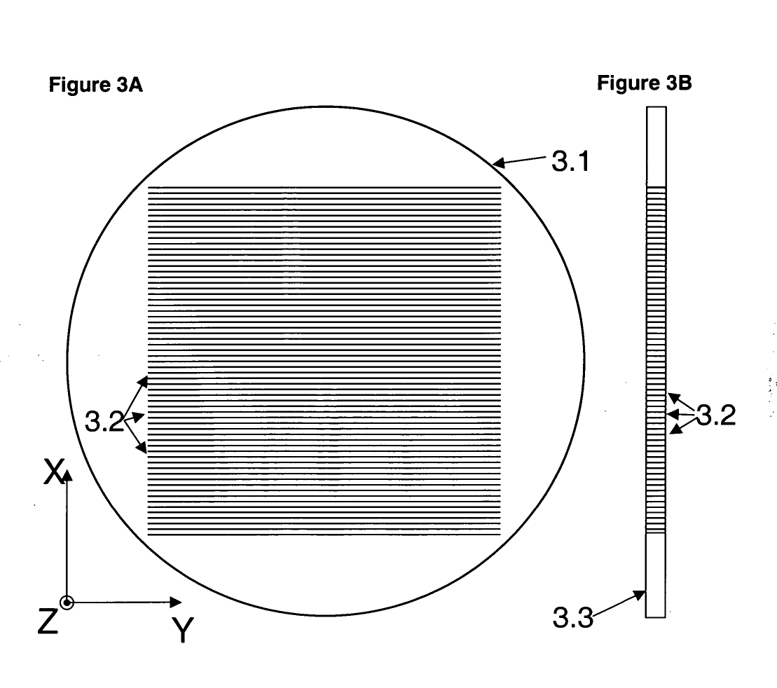

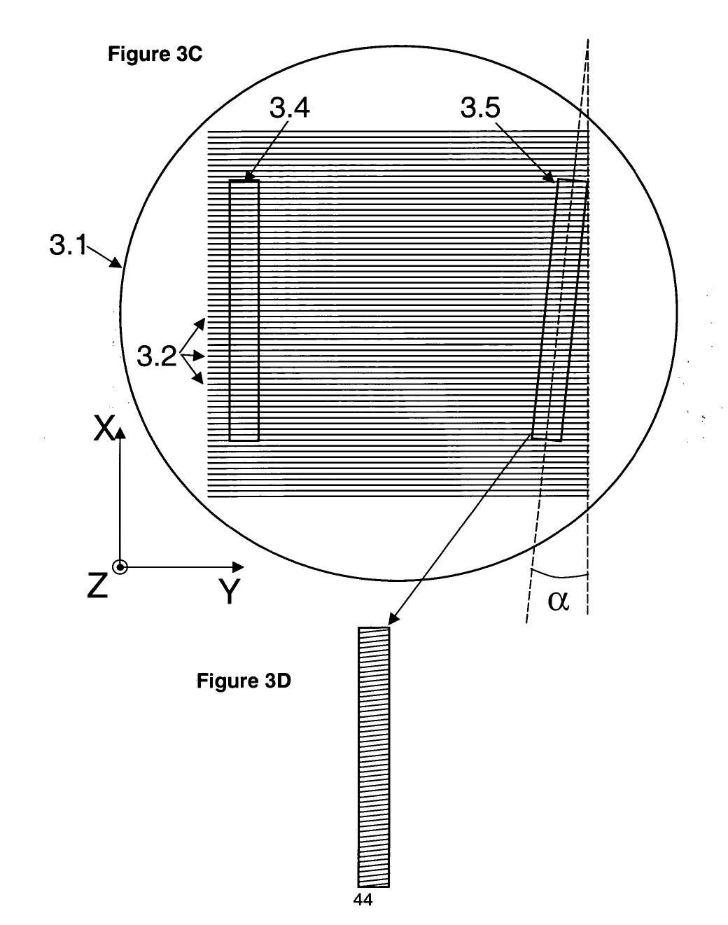

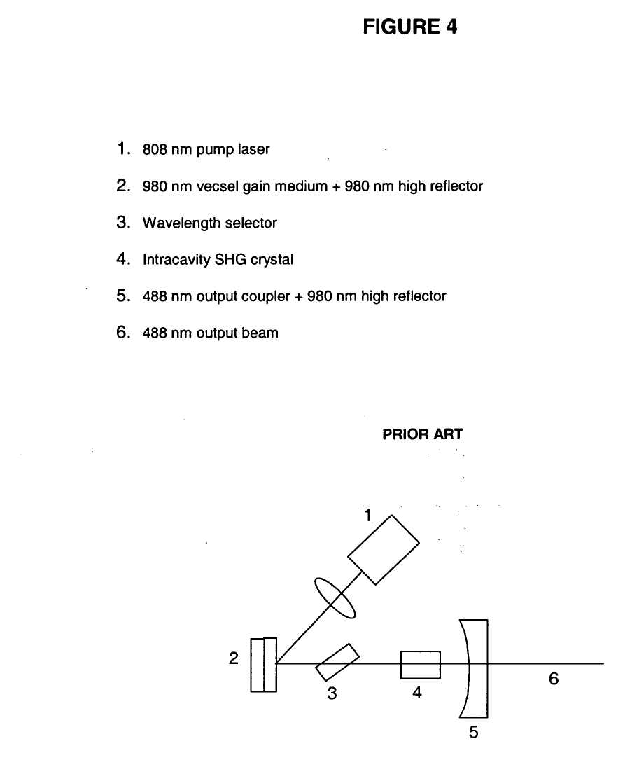

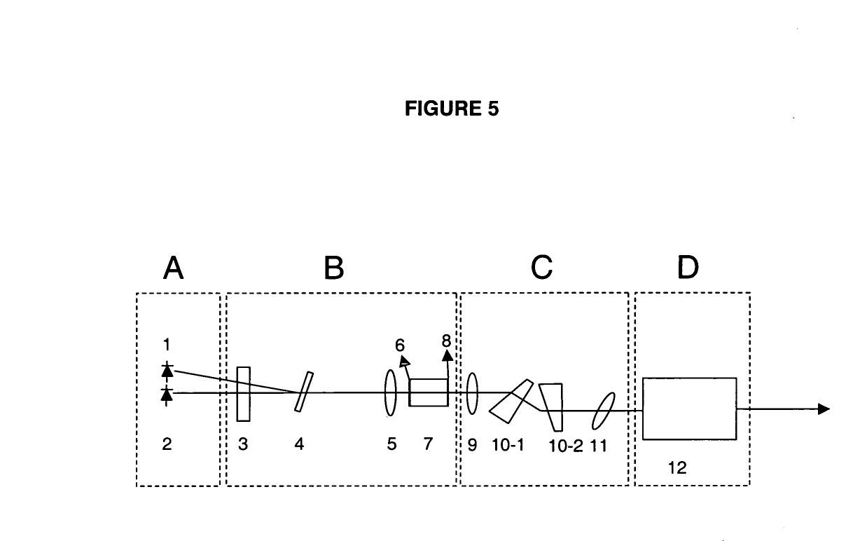

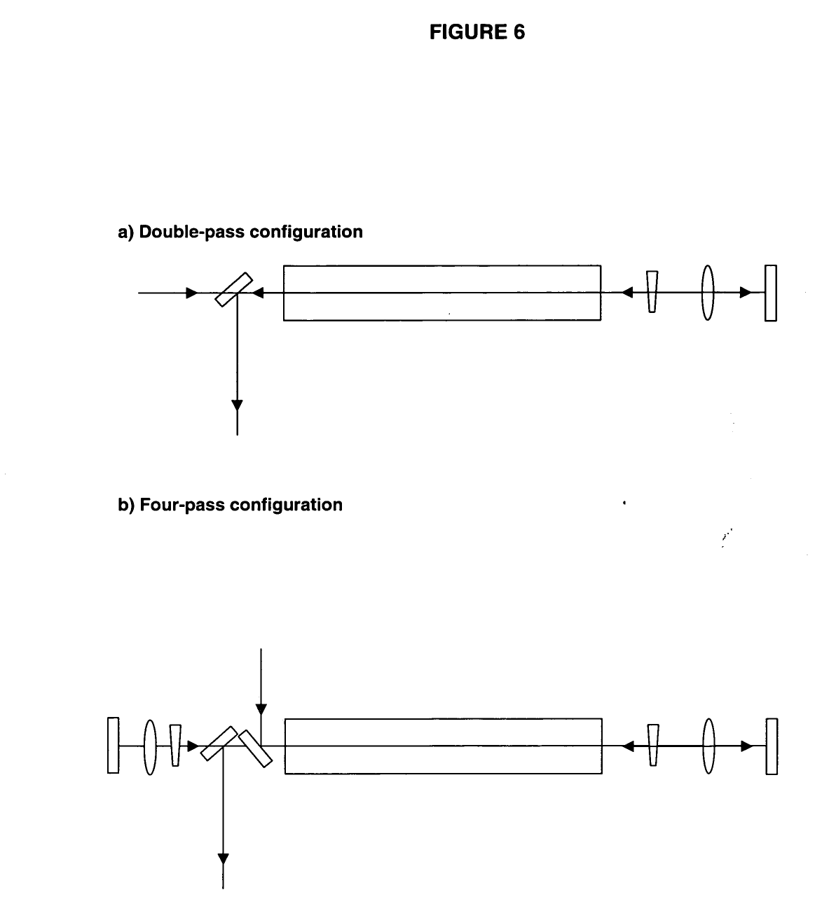

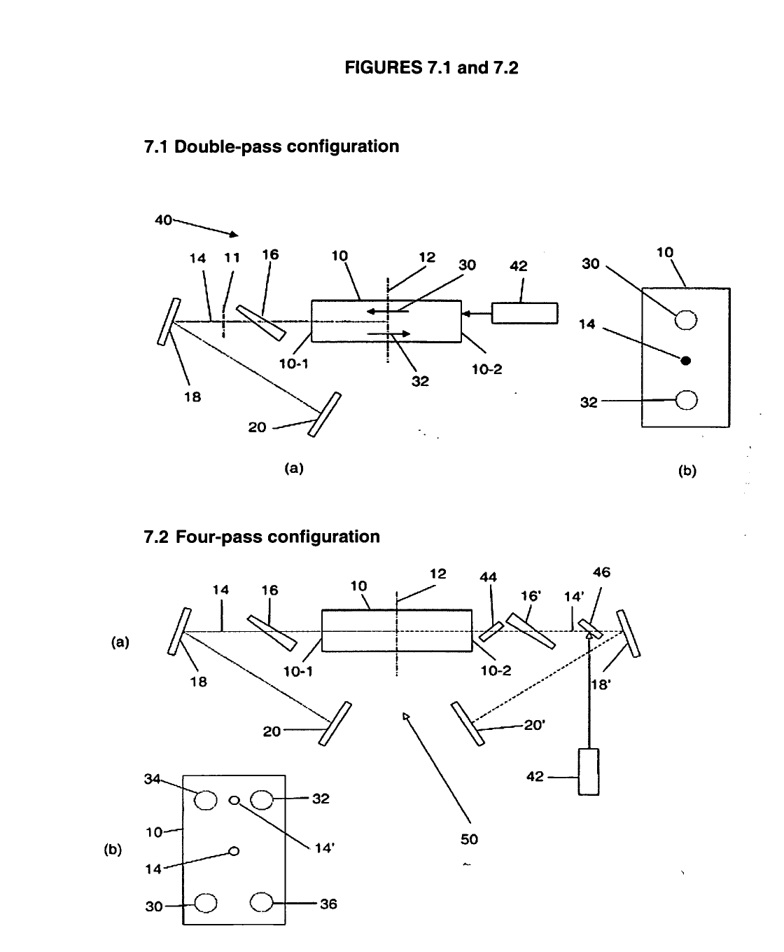

For purposes of clarity only five domain boundaries are shown. In actual practice the entire crystal would be periodically poled along the X axis. FIG. 1B illustrates a section of a crystal with three periods shown. The period width is the combined width of two adjoining regions of opposite polarity. Each period of a crystal prepared in accordance with the present invention will have a width of from about 2 microns to about 30 microns, preferably about 4 to about 7.5 microns.

FIGS. 2A and 2B show a periodically poled frequency doubling crystal in accordance with the present invention. For purposes of clarity in FIG. 2A only a single domain boundary is shown. In FIG. 2B five domain boundaries are shown. In an actual frequency doubling crystal, the periodic poling would be carried out along the entire X axis of the crystal and there would therefore be from 1000 to 10,000 domain boundaries over the entire length of the crystal. As can be seen, the plane of the domain boundary in FIGS. 2A and 2B is canted (tilted) with respect to the long axis of crystal but is substantially perpendicular to the side walls of the crystal. The cant angle will normally range from about 0.2° to about 2.0°, preferably 0.5° to 1.5° and is shown in a somewhat exaggerated form in FIGS. 2A and 2B for ease of visualization.

FIGS. 3A and 3B show top and side views of a crystal wafer fabricated from a suitable non-linear material such as Potassium Titanyl Phosphate (KTP), Lithium Niobate (LN) or Lithium Tantalate (LT). FIG. 3C shows a preferred way of fabricating the frequency doubling crystals of the present invention having canted poling planes in comparison with the fabrication of a periodically poled crystal in accordance with the prior art method. Circular crystal wafer (3.1) is shown with its X, Y, and Z axes indicated in conformity with those shown for the crystals in FIGS. 1 and 2, with the Z axis being into the plane of the Figure. The wafer is periodically poled vertically between the top and bottom surfaces of the wafer, using known technology as previously discussed, and the resulting domain boundaries (poling planes) are shown as lines 3.2. If the poled wafer is sliced (cut) to form a frequency doubling crystal as shown by the wafer segment 3.4, the resulting crystal would have domain boundaries perpendicular to the long axis (and the side walls) of the crystal as shown in FIG. 1A. Segment 3.5 shows the result of slicing the wafer so as to obtain a crystal in accordance with the present invention having its domain boundaries canted relative to the crystal long axis. Angle α in FIGS. 2A and 3C represents the degree of cant relative to the normal of the poling planes. Angle α will normally range from 0.2° to 2.0°. preferably 0.5° to 1.5°. Angle α is shown in FIG. 3C in exaggerated form to facilitate visualization.

FIG. 4 shows the architecture of a laser generating 488 nm light by means of intracavity second harmonic generation using an optically pumped semiconductor laser. In FIG. 4, No. 1 denotes an 808 nm pump laser, No. 2 a 976 nm VECSEL gain medium+a 976 nm high reflector, No. 3 a wavelength selector, No. 4 an intracavity SHG crystal, No. 5 a 488 nm output coupler+a 976 nm high reflector and No. 6 a 488 nm output beam.

FIG. 5 is a schematic diagram of a doubled external-cavity semiconductor laser (DECSL) for providing single pass second harmonic generation (SHG) of light.

FIGS. 6 and 7 are schematic diagrams of double and quadruple (four) pass DECSL configurations in accordance with the present invention.

FIG. 6a is a simplified schematic top view of a double pass embodiment of the invention.

FIG. 6b is a simplified schematic end view of a nonlinear medium in a double pass embodiment of the invention.

FIG. 7.1a is a schematic top view of a double pass embodiment of the invention, with 7.2b showing an end view of the nonlinear medium FIG. 7.2a is a schematic top view of a quadruple pass embodiment of the invention, with 7.2b showing an end view of the nonlinear medium.

### DESCRIPTION OF THE INVENTION

The improved frequency doubling crystals of the present invention can be advantageously utilized in conjunction with a wide variety of solid state lasers, including intracavity and VECSEL configurations. Moreover, we have identified a particular type of laser configuration, namely, a doubled external cavity semiconductor pump laser (DECSL) which, when utilized in conjunction with the improved nonlinear crystals fabricated in accordance with the teaching of the present invention, provides a particularly advantageous laser system which can emit light at selected wavelengths in the 300 to 700 nm range and demonstrates superior performance and reliability. Details of a DECSL laser system for producing 300 to 700 nm light using certain existing frequency doubling crystals are described in co-pending, commonly assigned U.S. patent application Ser. No. 10/966,309, filed Oct. 14, 2004, the disclosure of which is incorporated herein by this reference.

As previously discussed, feedback of emitted radiation to the pump laser gain medium from downstream components in the optical train can perturb the pump laser resonance conditions, thereby causing irregularities in the pump laser output power and/or adversely affecting wavelength stability. We have observed that as little as 60 db of back reflected light can have a measurable adverse effect. It is known to apply an anti-reflection coating to all of the facets of the downstream optical components which intersect the optical beam, including the frequency doubling crystal, to reduce this back reflection. The laser beam is transmitted down the long axis of the crystal (the X axis) and it is also known to cut the front and rear crystal facets (1.1 and 1.2 in FIG. 1) at a slight angle (not shown) so that the light emitted by the pump laser impinges on the crystal face at a non-zero angle of incidence, thereby ensuring that specular reflections from the front and back crystal facets do not return to the pump laser. The front and back crystal face angles, which can be the same or different, are normally in the range of about 0.2° to 2.0°, preferably 0.3° to 1.0°.

We have found that for many second harmonic generation crystals the use of both anti-refraction coatings and angled front and rear facets does not fully eliminate the undesirable back reflections. What has not heretofore been realized is that there can also be back reflection from the boundaries between the ferroelectric poling domains, i.e., by the poling planes, and that this back reflection can also cause deleterious reflections, normal to the poling planes, back into the pump laser. It is not clear why there would be reflections from these domain boundaries since the material of the frequency doubling crystal is generally thought to be substantially optically homogeneous throughout and certainly along its linear long axis. One explanation which we have, as yet, been unable to definitively prove, is that the poling process itself causes strain induced change in the index of refraction at the domain boundaries (“embedded refraction”). Of course, it would be possible to make the angle of incidence of the pump beam into the crystal non-normal to the crystal axis and thereby change the path of the beam through the crystal. However, since frequency doubling crystals are normally long and relatively thin and narrow, only a small deviation of angle of incidence from collinear with the crystal long axis would be possible before the incident beam would contact a side, the top or the bottom of the crystal. This adds an additional complication if a multipass design, which is frequently preferred, was utilized. We have found that if the poling planes are tilted (i.e. canted) at an angle of about 0.2° to 2.0°, preferably about 0.5° to 1.5°, relative to the long axis of the crystal, any back reflections from the crystal's domain interfaces will not cause a serious adverse effect on the performance of the pump laser. Tilting of the angle of incidence of the pump beam onto the domain interfaces might be expected to cause walk off of the beam and thereby a significant loss of conversion efficiency. However, we have found that significant walk off and loss of conversion efficiency does not occur when the poling planes are canted in accordance with the present invention.

As indicated, lasers emitting at wavelengths in the 300-700 nm range are particularly desired for biophotonic applications. Our novel laser design combines advances in laser diode technology with the advanced, periodically poled, nonlinear optical materials of the present invention to provide significantly enhanced frequency (wavelength) conversion efficiency, thereby enabling the resulting product to uniquely meet the stringent power, size and other performance constraints of biophotonic applications. Additionally, our unique optical architecture simplifies monitoring and control of the relevant optical parameters to thereby enable delivery of enhanced performance and reliability. A DECSL laser producing up to 100 mW of output power in the 300 to 700 nm wavelength range is schematically shown in FIG. 4. This laser configuration is preferred for use together with the frequency doubling crystals of the present invention.

The laser comprises a doubled, external cavity laser comprising an external cavity pump laser section, (B) monitor optics (Section A) to control the external cavity laser, beam shaping optics (Section C) to provide efficient second-harmonic generation when utilizing one, two or four passes through the extra-cavity frequency doubling section (Section D).

The pump laser section comprises an edge-emitting, semiconductor chip having:

i) an anti-reflection coating on the chip facet facing the end mirror

ii) a low reflectivity coating on the output facet facing the beam shaping region,

iii) a lens, a wavelength selector and a reflective element on the anti-reflection side of the chip for producing a single-mode output beam,

In Section A there is shown two monitors that measure the transmitted beam through the end mirror and the reflected beam from the wavelength selective element. Combining the signals of these two monitors allows accurate control over the wavelength of the external cavity pump laser. Section C includes beam shaping optics that produce an optical beam with minimal ellipticity and minimal astigmatism. A first lens collimates the divergent output of the edge emitter chip but produces an optical beam that has some residual astigmatism and ellipticity. The anamorphic prism pair provides (adjustable) magnification that is different in the vertical and horizontal planes. This way a circular beam, or a beam of selectable ellipticity, is produced. A tilted lens is suitably used to produce a focused beam into the second harmonic crystal that is free of astigmatism, or if preferred, with a selectable astigmatism

iv) at least one lens on the output side of said chip, which lens operates to collimate the chip output beam and direct said chip output beam to the frequency doubling section, which doubling section (D) which comprises:

i) a second harmonic generating crystal, selected from the group consisting of stoichiometric PPLT, MgO doped congruent PPLN and MgO doped stoichiometric PPLN, having pitched poling planes in accordance with the present invention.

ii) doubling optics configured such that the light path through the doubling crystal makes from one up to four collinear passes, and the second harmonic generation achieved when using multiple passes is constructive, and

iii) beam shaping optics to create a collimated, frequency doubled output beam.

A particular type of laser configuration, namely, a doubled external cavity semiconductor laser (DECSL), as described in U.S. patent application Ser. No. 10/966,309, when utilized in conjunction with the nonlinear optical crystals of the present invention, demonstrates the exceptional performance, reliability and cost needed to provide a suitable laser which emits light at selected wavelengths in the 300 to 700 nm range.

Achieving the requisite performance requires a unique combination of components for several reasons:

i) using single-pass SHG may not always allow one to achieve the required power level for all applications,

ii) when power requirements dictate the use of a double pass or quadruple pass architecture, achieving a reliable laser design that does not suffer from optical feedback is difficult. Our unique laser design and novel frequency doubling crystal provides two layers of protection to the DECSL pump laser (the component that suffers from feedback).

Using the generation of 488 nm (blue) light by way of example:
1. All the optical surfaces on which 976 nm radiation is incident are designed in such a way (with anti-reflection coated surfaces and/or face angled towards the input beam) so that the reflected light does not reflect back towards the pump laser.
2. The output consists of only one wavelength radiation, e.g., 488 nm. when the pump beam wavelength is 976 nm.
Note that although exact numbers are given (e.g., 488 nm and 976 nm) for wavelength, in actual practice the laser wavelength, whether before or after frequency doubling, can vary by as much as ±1 nm.

For example, to generate ˜488 nm light, a DECSL in accordance with the present invention would use a ˜976 nm semiconductor gain medium inside an external cavity containing a wavelength selective element such as a narrow band transmission filter, which causes the laser chip to emit only a single longitudinal mode. The radiation from the external cavity laser is doubled by the external SHG crystal to generate 488 nm light. The control system for the laser is robust, because the laser gain and the frequency doubling (SHG), both nonlinear phenomena, are controlled substantially independently. This independent control leads to greater amplitude stability and lower noise when compared to OPSL or other intracavity frequency conversion approaches. In comparison with prior art designs, our laser provides a output beam of stable amplitude and low noise which provides a greatly reduced tendency to cause false positive or negative results in biophotonic applications. However, because there is no intracavity enhancement to increase the available pump power, use of specific, high conversion efficiency nonlinear optical materials is highly advantageous in our design.

Because nonlinear optical crystals are limited in size, especially in length, owing to manufacturability constraints, in order to achieve higher output powers beyond those available by simply passing the light one time through the crystal, multi-pass schemes may be required in certain high power applications. When implemented correctly, the output power increases as the square of the number of passes through the crystal. An optimized, multi-pass frequency doubling design is described in co-pending, commonly assigned U.S. patent application Ser. No. 10/910,121, filed Aug. 3, 2004, the disclosure of which is incorporated herein by this reference.

If one considers, for example, typical biophotonics applications, the amount of light required can range from about 5 mW for imaging applications up to about 100 mW for applications such as those involving high throughput and multiplexed flow cells. This regime is often referred to as the “low power” regime (LPR) for solid-state lasers (as opposed to the medium power regime which typically encompasses about 200 mW to 1 W, and the high power regime, which is typically 2 W to 10 W). In the present invention, we address only the LPR for biophotonics applications. Biophotonics instruments for which the frequency doubling lasers of the present invention are particularly suitable include flow cytometers, DNA and RNA sequencers, and microarray, microplate imagers and confocal microscopes.

If one considers the DECSL architecture as described herein, a typical external cavity pump laser at e.g., 976 nm will be able to emit about 500 mW to 700 mW over its expected lifetime. For these output powers, the DECSL lifetime is consistent with the lifetime of most biophotonics instruments, namely about 20,000 hours of operation over a 5 to 7 year period. Such a laser should revolutionize the biophotonics instrument marketplace, because such lasers will no longer need to be replaced either every year (argon ion lasers) or at least every two years (OPSL technology).

However, a specific nonlinear optical material for the DECSL must be provided that can meet the service life and conversion efficiency requirements. For example, Lithium Borate (LBO) is a known SHG material, and it is used in numerous laser products today. It does, however, have certain critical shortcomings as shown in Table 1 (e.g., low SHG power). Likewise, Potassium Niobate (KNO) does not demonstrate adequate reliability and can suffer catastrophic damage from shock and/or low temperatures. Undoped Lithium Niobate (PPLN) crystals, whether congruent or stoichiometric, suffer from photorefractive damage, which limits their lifetimes. Periodically-poled Potassium Titanyl Phosphate (PPKTP), if not specially treated is also prone to develop photorefractive damage (grey tracking), which, of course, significantly limits its usefulness. Thus, we have identified the following non-linear frequency doubling materials as being uniquely capable of satisfying the power and lifetime service requirements of a laser suitable for biophotonic or other demanding applications:

MgO doped (3% to 5%) Congruent PPLN (Co PPLN)

MgO doped (0.2-1.0%) Stoichiometric PPLN (St PPLN)

Stoichiometric PPLT (StPPLT)

PPKTP (preferably fabricated in accordance with the teaching of copending, commonly assigned U.S. patent application Ser. No. 10/910,045)

The conversion efficiencies of the above-indicated, non-linear optical materials which we have found to have acceptable lifetimes, conversion efficiencies and robustness for biophotonics applications are given in Table 1, which also shows the material properties of some other less desirable, prior art nonlinear optical materials (LBO and KNO). The SHG power shown assumes a crystal length of 10 mm. The Max. length indicated is the maximum currently available crystal length (usually determined by boule growth capability).

TABLE 1

| | | | Max | | SHG |
|---|---|---|---|---|---|
| | d_{eff} | Refractive | Length | SHG Eff. | power |
| Material | [pm/V] | index | [mm] | [%/W/cm] | [mW] |
| LBO | ˜0.8 | 1.6 | 10 | 0.014 | 0.04 |
| KNO | 11.9 | 2.2 | 10 | 1.7 | 4 |
| PPKTP | 13 | 1.8 | 30 | 3 | 8 |
| MgO doped | 19 | 2.2 | 30 | 3.4 | 9 |
| Co PPLN | | | | | |
| St PPLT | 9 | 2.2 | 30 | 1.0 | 2.4 |

For a 500 mW 976 nm pump laser in a DECSL architecture, LBO does not produce sufficient second harmonic generation (SHG) power to meet many power requirements. For example, KNO, although it might be able to meet the power requirements, does not demonstrate adequate reliability. The optical properties of MgO doped stoichiometric PPLN are not significantly different from those of the MgO doped congruent material shown in Table 1. As already indicated, we have identified certain particular nonlinear crystals which have both sufficient robustness and produce sufficient single-pass power (and multi-pass power where still higher power is required) to be suitable for use in a DECSL architecture. As indicated, we have identified the crystals having any of the following compositions as being uniquely suitable:
i) MgO doped congruent or stoichiometric PPLN,
ii) Stoichiometric PPLT
iii) PPKTP

It should be particularly noted that although MgO doping to inhibit photorefractive damage is advantageous for both stoichiometric and congruent PPLN, the preferred doping levels differ. We have found that preferred MgO doping levels for congruent PPLN ranges from about 3-7%, while for stoichiometric PPLN a preferred range is from about 0.2 to 1.0%. All of these crystals provide improved performance when fabricated to have the pitched (angled) poling planes as described herein.

Since SHG power is approximately proportional to crystal length, and is also proportional to the square of the number of passes (N) in a multi-pass configuration, the applicability of each material to biophotonic or other demanding applications can now be assessed. Table 2 shows the potential space requirements for each of the crystal materials in the practice of the present invention for the three most common output powers required in biophotonics: 10 mW, 20 mW and 100 mW. Other commonly desired output powers are 30 mW, 40 mW and 75 mW. Table 2 also shows the design parameters for periodically poled materials for the three most common output powers. L is crystal length and N is the number of passes which would be used in a multi-pass DECSL design to achieve the indicated power output.

TABLE 2

| | 10 mW | | 20 mW | | 100 mW | |
|---|---|---|---|---|---|---|
| Material | L (mm) | N | L (mm) | N | L (mm) | N |
| MgO doped | 11 | 1 | 11 | 2 | 11 | 4 |
| congruent or | | | | | | |
| stoichiometric | | | 22 | 1 | 25 | 2 |
| PPLN | | | | | | |
| St PPLT | 12 | 2 | 25 | 2 | 25 | 4 |
| PPKTP | 12 | 2 | 25 | 2 | 25 | 4 |

The configuration of a single, two and four pass DECSL are shown schematically in FIGS. 5, 6 and 7. A four pass DECSL is generally considered to be the limit of practical manufacturability. As is clear from Table 2, a four pass architecture is sufficient to achieve the highest normally required output power (100 mW) for the majority of applications.

FIG. 5 shows a single pass frequency doubled laser design in accordance with the present invention. The sections of the laser are shown as follows:
A. Monitor optics for the external cavity laser
B. External cavity laser
C. Beam shaping optics
D. SHG section

The components present in each section are more particularly identified as follows:
1. reflection monitor
2. transmission monitor
3. 980 nm high reflector
4. wavelength selector
5. external cavity collimation lens
6. anti-reflection coated 980 nm gain chip facet
7. 980 nm gain chip
8. low-reflectivity coated 980 nm gain chip facet
9. collimation lens
10. anamorphic prism pair
11. tilted focusing lens
12. second-harmonic generating crystal

Section A contains known prior art components but is shown for purpose of clarity and completeness. In Section B there is present a 980 mm gain chip 7 with anti-reflection and low reflectivity coatings 6 and 8, respectively, collimation lens 5, wavelength selector 4 and high reflection mirror 3. Light emanating from face 8 of gain clip 7 passes through collimating lens 9 in Section C through prism pair 10-1 and 10-2 and then into focusing lens 11 and then into second harmonic generation Section D where it is frequency doubled by a SHG crystal of the materials described above and having the angled poling planes of the present invention. After frequency doubling the light passes out of the right side of Section D, as shown, for input into a flow cytometer or other medical device.

FIG. 7.1a is a schematic top view of a preferred embodiment of a double pass frequency doubling apparatus 40, in accordance with the present invention, while FIG. 7.1b is a schematic end view of a nonlinear medium 10 within apparatus 40. To appreciate the operation of apparatus 40, it is helpful to consider the beam paths through apparatus 40 before discussing the design of apparatus 40 in detail. A pump beam provided by a pump source (chip) 42 is received by a face 10-2 of nonlinear medium 10, and is transmitted along a beam path 30 through nonlinear medium 10. A second harmonic beam, having a frequency twice the pump frequency, is generated within nonlinear medium 10, and is also transmitted along beam path 30 through nonlinear medium 10. The pump and second harmonic beams are emitted from face 10-1 of nonlinear medium 10, and are received by a phasor 16. The beams are transmitted through phasor 16 and are received by a mirror 18. The pump and second harmonic beams are then reflected by mirror 18 and are received by a mirror 20. Both beams are reflected by mirror 20, reflected again from mirror 18, and received by face 10-1 of nonlinear medium 10. The second pass pump and second harmonic beams are transmitted along a beam path 32 through nonlinear medium 10, and are emitted from face 10-2 of nonlinear medium 10.

Beam paths 30 and 32 through nonlinear medium 10 are preferably parallel to, and spaced apart from, each other, as indicated. This can be accomplished by choosing mirrors 18 and 20 such that they act as an inverting telescope to re-image a reference plane 12 located at the center of nonlinear medium 10 onto itself with negative unity magnification. Axis 14 is the axis of the telescope formed by mirrors 18 and 20, and is substantially centered within nonlinear medium 10. Thus, beam path 32 is the image of beam path 30 formed by the inverting telescope, and separation of beam paths 30 and 32 is obtained by offsetting beam path 30 from axis 14 as indicated in FIG. 7.1b. This separation of the second pass (beam path 32) from the first pass (beam path 30) is advantageous, since no additional optical elements are required to separate the second pass beams from the first pass beams.

The chemical composition of the nonlinear medium 10 can be any one of the materials already described herein as being suitable for the practice of the present invention. To avoid reflection of the pump beam back into the pump source; preferably face 10-2 of nonlinear medium 10 is slightly tilted (on the order of 0.2 degree to 2.0 degrees) so that the pump beam is not exactly normally incident on face 10-2 of nonlinear medium 10. This helps prevent the pump beam being reflected from face 10-2 of nonlinear medium 10 and coupling back into the pump source. Preferably also, faces 10-1 and 10-2 of nonlinear medium 10 are anti-reflection coated to provide a low reflectivity (i.e. reflectivity <1 percent, more preferably <0.5 percent) at both the pump frequency (wavelength) and second harmonic frequency (wavelength) to reduce loss in apparatus 40. Of course, as already described, a significant aspect of the present invention is to angle the domain poling planes of the crystal 0.2° to 2.0° to reduce to the maximum extent the harmful effects of back reflection.

The purpose of phasor 16, which is an optional component, is to adjust the relative phase of the pump and second harmonic beams as the beams enter nonlinear medium 10 for a second or subsequent pass (i.e., beam path 32) so that the second pass contributes constructively to the second harmonic beam already present from the first pass. Phasor 16 is fabricated as a wedged plate of a dispersive optical material, i.e., a material which has a different index of refraction at the pump frequency and second harmonic frequency, where the wedge angle between the phasor surfaces is roughly on the order of 0.1 degree to 1 degree. Because phasor 16 is a wedged plate, the amount of dispersive material it introduces into the beam path is variable by translating the phasor perpendicular to the beams. For example, consider doubling of 976 nm radiation to 488 nm. A suitable material for phasor 16 is the commercial glass BK7, which has n_{ω}=1.508 and n_{2ω}=1.522 at these wavelengths, respectively. The coherence length of BK7 in this example is L_{c}=17.4 μm. Since the beam makes a double pass through phasor 16, a full 2π adjustment of the relative phases of pump and second harmonic beams is obtained by varying the phasor thickness seen by the beams by L_{c}=17.4 μm. Phasor 16 is preferably inserted into assembly 40 so that both pump and second harmonic beams are incident on phasor 16 at or near Brewster's angle and have p polarization (i.e., electric field vector lying in the plane of incidence of a phasor surface), to reduce reflection losses from the surfaces of phasor 16. Alternatively, phasor 16 may have an antireflection coating on its optical surfaces so that the phasor can be used at angles other than Brewster's angle without introducing substantial reflection losses.

Mirror 18 is a concave mirror with a radius of curvature R. Mirror 20 is a flat mirror which is separated from mirror 18 by a length L which is substantially equal to the focal length f=R/2 of mirror 18. Mirrors 18 and 20 are highly reflective (with reflectivity preferably greater than 99.5 percent) at both the pump and second harmonic frequencies. Mirrors 18 and 20 together form a telescope subassembly having an ABCD matrix (for both the pump and second harmonic beams) with A=−1, C=0 and D=−1, with respect to an input and output reference plane 11 located between mirror 18 and phasor 16. The ABCD matrix describes the geometrical imaging properties of an optical system as follows:

$$( \begin{matrix}y \\ {y}^{′}\end{matrix} ) = ( \begin{matrix}A & B \\ C & D\end{matrix} ) ( \begin{matrix}x \\ {x}^{′}\end{matrix} ) \qquad ( 1 )$$

where x and x′ are the position and slope, respectively, of an input ray relative to the optical axis of the system (i.e., axis 14 on FIG. 3.1a) at the input reference plane of the optical system, and y and y′ are the position and slope, respectively, of the corresponding output ray at the output reference plane of the optical system. For optical systems which retro-reflect a beam, it is frequently convenient to select the same plane (e.g., reference plane 11) as the input reference plane and as the output reference plane.

Mirror 18 is preferably positioned such that the diffractive distance between reference plane 12 at the center of nonlinear medium 10 and mirror 18 is substantially equal to the focal length of mirror 18. The diffractive distance between two points separated by regions of length Lᵢ and index nᵢ is ΣLᵢ/nᵢ. With this relative positioning of mirror 18 and nonlinear medium 10, reference plane 12 is re-imaged onto itself (with −1 magnification, i.e., inversion) by the telescope subassembly. This ensures that optimal focusing is preserved from one pass to the next. That is, if the first pass pump beam is optimally focused through nonlinear medium 10, (i.e., it has a beam waist of the appropriate size at reference plane 12 at the center of nonlinear medium 10), the second pass pump beam will also be optimally focused through nonlinear medium 10.

Although the primary purpose of the telescope subassembly is to couple the pump and second harmonic beams emitted from nonlinear medium 10 after the first pass back into nonlinear medium 10 for a second pass, the above properties of the ABCD matrix of the telescope subassembly have additional advantageous consequences.

The condition C=0 ensures that the output ray slope depends only on the input ray slope (i.e., it does not depend on input ray position). Therefore, two rays which are parallel at the input of an optical system with C=0 will be parallel at the output of that system. Optical systems with C=0 are telescopes. For multipass SHG, the preservation of parallelism provided by a telescope is especially valuable, because the parallelism of the pump beam with the second harmonic beam on the first pass is preserved in the second pass, which significantly simplifies alignment. In apparatus 40, if C=0 at reference plane 11, C is also 0 at reference plane 12, since there are no focusing elements between reference plane 11 and reference plane 12. Thus, if the first pass pump and second harmonic beams are parallel within nonlinear medium 10, then the second pass pump and second harmonic beams will also be parallel within nonlinear medium 10.

The condition D=−1 ensures that the first pass and second pass ray slopes of the pump beam (and the first pass and second pass ray slopes of the second harmonic beam) are identical between phasor 16 and mirror 18. The sign change of the ray slope from D=−1 is cancelled out by the sign change due to the reversal of the optical axis. This equality of ray slopes also extends into nonlinear medium 10, since there are no focusing elements between mirror 18 and nonlinear medium 10, so the second pass pump beam is parallel to the first pass pump beam within nonlinear medium 10, and the second pass second harmonic beam is parallel to the first pass second harmonic beam within nonlinear medium 10. Parallelism between first and second passes is advantageous because phase-matching typically has a narrow angular acceptance. If the first and second passes go through nonlinear medium 10 at significantly different angles, it may be impossible to efficiently phase-match both passes simultaneously.

The preservation of beam parallelism between first and second passes, as well as between the pump and second harmonic beams, also ensures that the linearly varying thickness of phasor 16 across the beams is cancelled in a double pass through phasor 16. In other words, the relative phase shift imparted to the second harmonic beam relative to the pump beam by a double pass through phasor 16 does not vary from point to point within the beams. Similarly, if nonlinear medium 10 has a linearly varying thickness from point to point within the beams (e.g. if face 10-1 is tilted with respect to the beams and face 10-2 is not tilted), the effect due to this variable thickness is cancelled in a double pass.

The arrangement of mirror 18 and mirror 20 shown in FIG. 5.1 is a preferred telescope subassembly, since mirror 18 has the same focal length at both the pump and second harmonic frequencies. Other telescope subassemblies with A=−1, C=0 and D=−1 (at both pump and second harmonic wavelengths) are also suitable for practicing the invention. In all cases it is preferred to position the telescope subassembly relative to nonlinear medium such that reference plane 12 at the center of nonlinear medium 10 is substantially re-imaged onto itself with −1 magnification, in order to preserve optimal focusing from one pass to the next.

Although the telescope subassembly with A=−1, C=0 and D=−1 ensures beam parallelism within nonlinear medium 10, beam collinearity within nonlinear medium 10 is not ensured by the telescope subassembly. In other words, it is possible for the second pass second harmonic beam axis to be laterally separated from the second pass pump beam axis, even though the pump and second harmonic beam axes are collinear on the first pass. Two sources of this undesirable beam offset are the dispersion of phasor 16 and the dispersion of nonlinear medium 10 (if the beams intersect face 10-1 of nonlinear medium 10 at a non-normal angle of incidence). The beam offset is affected by the wedge angle of phasor 16, the nominal thickness of phasor 16, the length of nonlinear medium 10 (assuming the design is constrained to re-image reference plane 12 onto itself with −1 magnification), the angle of incidence on face 10-1 of nonlinear medium 10, and the distance between phasor 16 and nonlinear medium 10. Since varying these parameters changes the beam offset without affecting the parallelism preserving property of the telescope subassembly, the beam offset can be eliminated by design.

An additional consideration in a detailed design is astigmatism compensation, because phasor 16 and mirror 18 can both cause astigmatism. The relevant parameters are the thickness, incidence angle and wedge angle of phasor 16, and the focal length and incidence angle of mirror 18. Again, these parameters offer enough flexibility to eliminate the net astigmatism of apparatus 40 by design (i.e., by ensuring that the astigmatism of phasor 16 compensates for the astigmatism of mirror 18, and conversely). In addition, there are enough parameters to eliminate astigmatism and to preserve collinearity simultaneously. It is desirable to ensure that apparatus 40 has no net astigmatism, so as to maximize conversion efficiency and also to provide a non-astigmatic second harmonic beam after the second pass. It is also possible to eliminate astigmatism from apparatus 40 by adding one or more optical elements to apparatus 40 in accordance with known principles of telescope astigmatism compensation.

FIG. 7.2 is a schematic top view of a four pass frequency doubling apparatus 50, in accordance with the present invention, while FIG. 7.2b is a schematic end view of nonlinear medium 10 within apparatus 50. To appreciate the operation of apparatus 50, it is helpful to consider the beam paths through apparatus 50 before discussing the design of apparatus 50 in detail. A pump beam is received by face 10-2 of nonlinear medium 10, and is transmitted along beam path 30 through nonlinear medium 10. A second harmonic beam, with frequency twice the pump frequency, is generated within nonlinear medium 10, and is also transmitted along beam path 30 through nonlinear medium 10. The pump and second harmonic beams are emitted from face 10-1 of nonlinear medium 10, and are received by phasor 16. The beams are transmitted through phasor 16 and are received by mirror 18. The pump and second harmonic beams are reflected by mirror 18 and are received by mirror 20. Both beams are reflected by mirror 20, reflected again from mirror 18, transmitted again through phasor 16, and received by face 10-1 of nonlinear medium 10. The pump and second harmonic beams are transmitted in a second pass along beam path 32 through nonlinear medium 10, and are emitted from face 10-2 of nonlinear medium 10.

These two emitted beams are received by a phasor 16′, transmitted through phasor 16′, received by a mirror 18′, reflected from mirror 18′ and received by a mirror 20′. After reflection from mirror 20′, the pump and second harmonic beams are reflected again from mirror 18′, transmitted again through phasor 16′, and received by face 10-2 of nonlinear medium 10. The pump and second harmonic beam are transmitted in a third pass along beam path 34 through nonlinear medium 10, and are emitted from face 10-1 of nonlinear medium 10.

These two emitted beams are received by phasor 16, transmitted through phasor 16, received by mirror 18, reflected from mirror 18, and received by mirror 20. After reflection from mirror 20, the pump and second harmonic beams are reflected again from mirror 18, transmitted again through phasor 16, and received by face 10-1 of nonlinear medium 10. The pump and second harmonic beams are transmitted in a fourth pass along beam path 36 through nonlinear medium 10, and are emitted from face 10-2 of nonlinear medium 10.

Beam paths 30, 32, 34 and 36 through nonlinear medium 10 are separated from each other, as indicated on FIG. 7.2b. This is accomplished by choosing mirrors 18 and 20 such that they act as a first inverting telescope to re-image reference plane 12 located at the center of nonlinear medium 10 onto itself with negative unity magnification. Axis 14, which is the axis of the telescope formed by mirrors 18 and 20, is substantially centered within nonlinear medium 10 as indicated on FIG. 7.2b. Thus, beam path 32 is the image of beam path 30 formed by the inverting telescope, and separation of beam paths 30 and 32 is obtained by offsetting beam path 30 from axis 14 as indicated on FIG. 7.2b. Mirrors 18′ and 20′ are also selected such that they act as an inverting telescope to re-image reference plane 12 onto itself with negative unity magnification. Axis 14′ is the axis of the telescope formed by mirrors 18′ and 20′, and is offset from axis 14 as indicated on FIG. 7.2b. Thus, third pass beam path 34 is the image of second pass beam path 32 formed by this second inverting telescope.

Similarly, fourth pass beam path 36 is the image of third pass beam path 34 formed by the first inverting telescope with axis 14. Therefore, all four passes follow distinct paths through nonlinear medium 10, where second pass beam path 32 is the inversion of first pass beam path 30 about axis 14, third pass beam path 34 is the inversion of second pass beam path 32 about axis 14′, and fourth pass beam path 36 is the inversion of third pass beam path 34 about axis 14.

Since the four passes in apparatus 50 do not overlap, no beam splitters (which introduce undesirable loss) are required to couple the pump beam into apparatus 50, or to couple the second harmonic beam out of apparatus 50. A preferred method for coupling the pump beam into apparatus 50 is to position a pump turning mirror 46 within apparatus 50 so that a pump beam provided by pump source 42 is reflected to follow beam path 30 through nonlinear medium 10, and such that pump turning mirror 46 does not block the second pass beams following beam path 32 through nonlinear medium 10 or the third pass beams following beam path 34 through nonlinear medium 10.

A preferred method for coupling the second harmonic beam out of apparatus 50 is to position a second harmonic turning mirror 44 within apparatus 50 so that the fourth pass second harmonic beam following beam path 36 through nonlinear medium 10 is reflected out of apparatus 50, and such that second harmonic turning mirror 44 does not block the first pass pump beam following beam path 30 through nonlinear medium 10, the second pass beams following beam path 32 through nonlinear medium 10, or the third pass beams following beam path 34 through nonlinear medium 10.

Phasor 16′ has the same characteristics as phasor 16 in FIG. 7.1. The first and second telescopes in apparatus 50 (formed by mirrors 18 and 20, and by mirrors 18′ and 20′, respectively) are both designed as indicated in the discussion of FIG. 3.1a, i.e., with A=D=−1 and C=0 at the relevant phasor (i.e., phasor 16 for the telescope formed by mirrors 18 and 20, and phasor 16′ for the telescope formed by mirrors 18′ and 20′), and designed to re-image reference plane 12 onto itself with −1 magnification. This arrangement provides the advantages of beam parallelism on all four passes, and beam collinearity and astigmatism compensation by design, also as indicated above. In addition, phasor 16 applies the same relative phase shift between the first and second passes of the beams as it does between the third and fourth passes of the beams. Because the beam pattern for the four passes is highly symmetrical, the required phase shift between the first and second passes and between the third and fourth passes is the same. Therefore, phasor 16 can simultaneously provide the required phase shift between the first and second passes, as well as between the third and fourth passes, which is highly desirable compared to an alternative where three independent phasors are used in four pass SHG. Even if a linearly varying phase shift is imposed on the beams by nonlinear medium 10 (e.g. if face 10-1 is not exactly perpendicular to the beam axes), this variation is cancelled in double pass, and phasor 16 will still simultaneously provide the required phase shift between the first and second passes, as well as between the third and fourth passes.

Implicit in the above discussion is an assumption that the pump beam and second harmonic beam are collinear within nonlinear medium 10 on the first pass. This assumption is frequently applicable (e.g. for collinear QPM or collinear BPM with negligible beam walkoff). In some cases, such as birefringent phase-matching with nonzero beam walkoff, the pump and second harmonic beams are not collinear over the entire length of nonlinear medium 10. In other cases, such as non-collinear phase-matching, the pump and second harmonic beams are not parallel within nonlinear medium 10. For these cases, the apparatus and methods discussed above are also advantageous, since compensation methods analogous to the lateral offset compensation discussed above can be applied to ensure that the second pass “undoes” the divergence of the pump beam from the second harmonic beam caused by the first pass. Similarly, the fourth pass can “undo” the relative divergence of the two beams caused by the third pass, etc. The advantageous phase adjustment provided by a wedged phasor can be obtained in embodiments of the invention which do not include an inverting telescope.

By combining a DECSL laser configuration with the uniquely superior periodically poled nonlinear optical materials (pitched poling plane frequency doubling crystals) prepared in accordance with the teaching of the present invention, a highly controllable, high reliability laser can be built. Moreover, the laser design of the current invention provides high wavelength stability and low intensity noise.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed,

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions herein relate to specific embodiments of the invention, it is to be understood that where a specific feature is disclosed in the context of a particular figure or embodiment, such feature can also be used, to the extent appropriate, in the context of another figure or embodiment, in combination with another feature, or in the invention in general. Further, while the present invention has been particularly described in terms of certain preferred embodiments, the invention is not limited to such preferred embodiments. Rather, the scope of the invention is defined by the appended claims.

1. A periodically poled second harmonic generating crystal having a long axis X, said crystal comprising Magnesium Oxide doped Congruent Lithium Niobate, Magnesium Oxide doped Stoichiometric Lithium Niobate, Stoichiometric Lithium Tantalate or Potassium Titanyl Phosphate wherein the poling planes of said periodically poled crystal are canted relative to said X axis at an angle ranging from about 0.2° to about 2.0°.

2. A crystal in accordance with claim 1 comprising Magnesium Oxide doped Congruent Lithium Niobate.

3. A crystal in accordance with claim 1 comprising Magnesium Oxide doped Stoichiometric Lithium Niobate.

4. A crystal in accordance with claim 1 comprising Stoichiometric Lithium Tantalate.

5. A crystal in accordance with claim 1 comprising Potassium Titanyl Phosphate

6. A crystal in accordance with claim 1 wherein said cant angle ranges from about 0.5° to about 1.5°.

7. A crystal in accordance with claim 1 having a period width ranging from about 2 microns to about 30 microns.

8. A crystal in accordance with claim 7 having a period width ranging from about 4 microns to about 7.5 microns.

9. A process comprising the steps of:
i) fabricating a substantially planar wafer having top and bottom surfaces, comprising crystalline Magnesium Oxide doped Congruent Lithium Niobate, Magnesium Oxide doped Stoichiometric Lithium Niobate, Stoichiometric Lithium Tantalate or Potassium Titanyl Phosphate,
ii) producing on said wafer a plurality of periodically poled domains whose planes are vertically disposed between said top and bottom surfaces,
iii) removing a right angle rectangular parallelepiped shaped segment of said poled area, the long axis of which segment is at an angle a relative to the normal to said poling planes.

10. A process in accordance with claim 9 wherein a has an value ranging from about 0.2° to about 2.0°.

11. A process in accordance with claim 10 wherein a has an value ranging from about 0.5° to about 1.5°.

12. A process in accordance with claim 9 wherein said wafer comprises Magnesium Oxide doped Congruent Lithium Niobate.

13. A process in accordance with claim 9 wherein said wafer comprises Magnesium Oxide doped Stoichiometric Lithium Niobate.

14. A process in accordance with claim 9 wherein said wafer comprises Stoichiometric Lithium Tantalate.

15. A process in accordance with claim 9 wherein said wafer comprises Potassium Titanyl Phosphate.

16. A doubled, external cavity laser comprising an external cavity pump laser section and an extra-cavity frequency doubling section, said pump laser section comprising an edge-emitting, semiconductor chip having:
i) an anti-reflection coating on the chip facet facing the end mirror,
ii) a low reflectivity coating on the output facet facing the beam shaping optics,
iii) means on the anti-reflection side of said chip for producing a single-mode output beam,
iv) at least one lens on the output side of said chip which lens operates to collimate the chip output beam and direct said chip output beam to the frequency doubling section, which doubling section comprises:
v) a second harmonic generating crystal in accordance with claim 1
vi) doubling optics configured such that the light path through the doubling crystal makes from one up to four collinear passes, and the second harmonic generation achieved through multiple passes is constructive,
vii) beam shaping optics to create a collimated, frequency doubled output beam.

17. A laser in accordance with claim 16 wherein said crystal material is MgO doped stoichiometric PPLN or MgO doped congruent PPLN.

18. A laser in accordance with claim 16 wherein said crystal material is MgO doped congruent PPLN.

19. A laser in accordance with claim 16 wherein said crystal material is stoichiometric PPLT.

20. A laser in accordance with claim 16 wherein said crystal material is PPKTP.

21. A laser in accordance with claim 16 wherein said frequency doubled output beam has a wavelength of substantially 488 nm.

22. A laser in accordance with claim 16 wherein said frequency doubled output beam has a wavelength of substantially 505 nm.

23. A laser in accordance with claim 16 wherein said frequency doubled output beam has a wavelength between 528 nm and 532 nm.

24. A laser in accordance with claim 16 wherein said frequency doubled output beam has a wavelength between 350 nm and 360 nm.

25. A laser in accordance with claim 16 wherein said doubling optics cause said chip output beam to make two or four collinear passes through said doubling crystal.

26. A laser in accordance with claim 16 wherein said beam shaping optics comprise a collimation lens, an anamorphic prism pair and a tilted focusing lens.

27. A laser in accordance with claim 16 wherein said doubling optics comprise a phasor and at least two mirrors.

28. A laser in accordance with claim 27 wherein said mirrors act as an inverting telescope.

29. A laser in accordance with claim 16 wherein the faces of said frequency doubling crystal are anti-reflection coated.

30. The laser of claim 1 operably connected to provide the light source to a biomedical instrument selected from the group consisting of flow cytometers, DNA sequencers, RNA sequencers and confocal microscopes.
